(19) United States
(12) Patent Application Publication
(10) Pub. No.: US 2020/0002977 A1
(43) Pub. Date: Jan. 2, 2020

(54) DOOR ACCESS DEVICE

(71) Applicant: HEWLETT-PACKARD DEVELOPMENT COMPANY, LP., Spring, TX (US)

(72) Inventor: Natalia Russi-Vigoya, Spring, TX (US)

(73) Assignee: HEWLETT-PACKARD DEVELOPMENT COMPANY, LP., Spring, TX (US)

(21) Appl. No.: 16/486,496

(22) PCT Filed: Feb. 17, 2017
(86) PCT No.: PCT/US2017/018389

§ 371 Date: Aug. 15, 2019

(51) Int. Cl. E05B 51/00; E05B 43/00; E05B 39/00; E05B 35/00; G07C 9/00

(52) U.S. Cl. CPC E05B 51/00; E05B 43/005; E05B 47/0001; E05B 35/00; G07C 9/00563; E05B 39/00

(57) ABSTRACT

Door access devices are disclosed. An example door access device includes a door handle to open a door and a fingerprint reader disposed on a rear side of the door handle to read a fingerprint from a user touching the rear side of the door handle. The fingerprint reader is obscured from view from a vantage of the user attempting to open the door.

### BACKGROUND

A door lock is conventionally used in a door to control access to a restricted area, such as an interior of a house or a business, beyond the door. Authorized users (e.g., a homeowner and family members, a business owner, an employee of a business, etc.) are provided with a physical or electronic key to unlock a door lock to access the restricted area. Prospective users (e.g., guests, customers, service personnel, etc.) of the door seeking to gain access to the restricted area are selectively granted access to the restricted area by an authorized user. In some instances, unauthorized users (e.g., strangers, criminals, uninvited guests, etc.) may successfully or unsuccessfully attempt to enter a restricted area through a door.

### BRIEF DESCRIPTION OF THE DRAWINGS

FIGS. 1A-1B depict example door access devices constructed in accordance with teachings of this disclosure.

FIG. 2A is a block diagram of a first example door access system, including the example door access device 100 of FIG. 1A, constructed in accordance with teachings of this disclosure.

FIG. 2B is a block diagram of a second example door access system, including the example door access device 100 of FIG. 1A, constructed in accordance with teachings of this disclosure.

FIG. 2C is a block diagram of a third example door access system, including the example door access device 100 of FIG. 1B, constructed in accordance with teachings of this disclosure.

FIG. 3 is a block diagram of an example implementation of the identifier of FIG. 2A, 2B and/or 2C.

FIGS. 4-8 are flowcharts representative of machine readable instructions which may be executed to implement the identifier of FIG. 3 and/or the door access systems of FIG. 2A, 2B and/or 2C.

FIG. 9 is a block diagram of an example processor platform which may execute the example instructions of FIGS. 4-8 to implement the identifier of FIG. 3 and/or the door access systems of FIG. 2A, 2B and/or 2C.

The figures are not to scale. Instead, to clarify multiple layers and regions, the thickness of the layers may be enlarged in the drawings. Wherever possible, the same reference numbers will be used throughout the drawing(s) and accompanying written description to refer to the same or like parts. As used in this patent, stating that any part (e.g., a layer, film, area, or plate) is in any way positioned on (e.g., positioned on, located on, disposed on, or formed on, etc.) another part, means that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

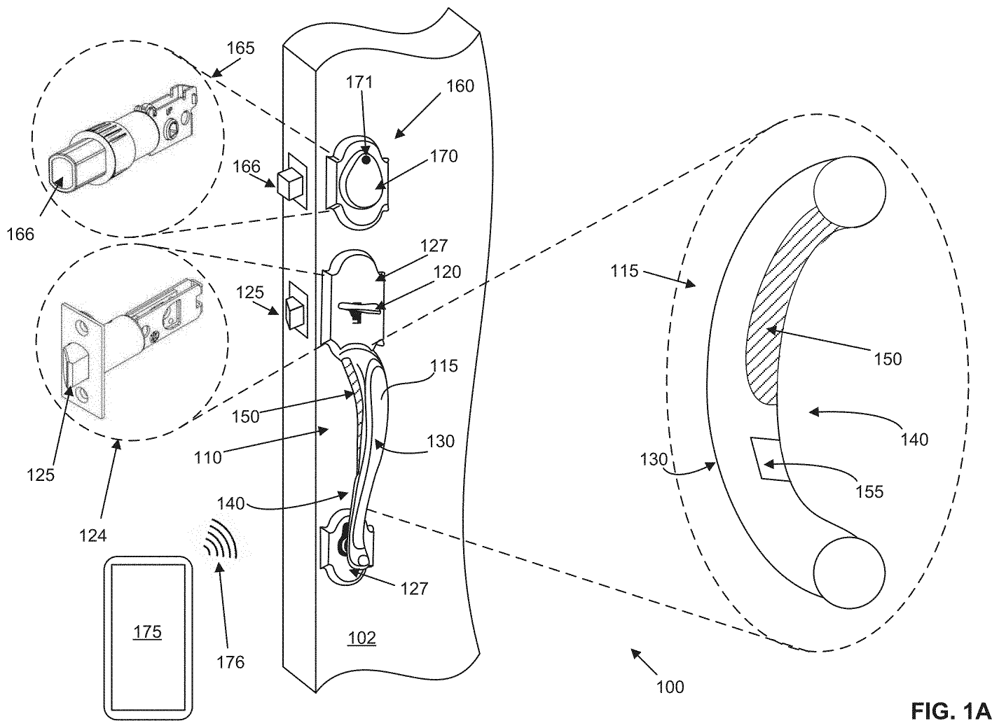

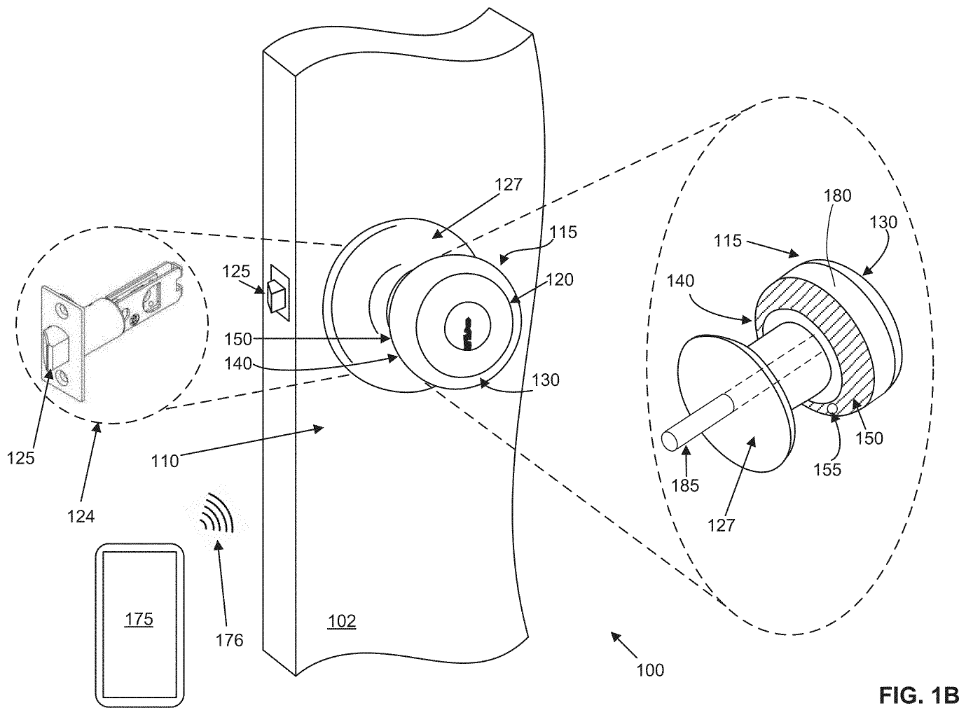

FIG. 1A depicts an example door access device 100 in accordance with teachings of this disclosure. The example door access device 100 of FIG. 1A is provided on an example door 102, which may be an exterior door or an interior door. The example door 102 includes an example door handle assembly 110. The example door handle assembly 110 of FIG. 1A includes an example door handle 115 and an example thumb piece 120. The thumb piece 120 is actuatable to operate an example latch assembly 124 to control an example latch 125. The example thumb piece 120, responsive to depression by a user's thumb, moves the example latch 125 from an extended position in which the example latch 125 engages a strike plate in a door frame, to a retracted position in which the example latch 125 does not engage the strike plate, to thereby permit rotation of the example door 102 relative to the door frame about hinges. In the illustrated example, a base 127 of the example door handle assembly 110 is attached to the example door 102.

The example door handle 115 of FIG. 1A includes an example front side 130 and an example rear side 140. The example front side 130 of the example door handle 115 is visible to a user of the example door 102 when engaging the example door access device 100, whereas the rear side 140 of the example door handle 115 is generally obscured from the view of the user during normal use (e.g., when seeking to grasp the example door handle 115 and to operate the example thumb piece 120). FIG. 1A shows an example fingerprint reader 150 disposed on the example rear side 140 of the example door handle 115 in a position that is obscured from the view of a user of the example door 102. An exploded and reversed representation of the example door handle 115 is provided on the right hand side of FIG. 1A to show the example fingerprint reader 150, on the example rear side 140 of the example door handle 115. In some examples, the example fingerprint reader 150 is open for direct contact by the user. In some examples, the example fingerprint reader 150 is covered by a protective surface, such as a glass cover, a silicon substrate, a coating, or a film.

The positioning of the example fingerprint reader 150 on the example rear side 140 of the example door handle 115 in a position of relative obscurity advantageously avoids visually informing a prospective user of the example door 102 of the ability of the example door handle 115 to read the user's fingerprint if the user naturally engages the example door handle 115 to open the example door 102. For instance, in the example of FIG. 1A, a natural engagement of the depicted example door handle would include touching a back portion of the example door handle 115 when grasping the example door handle 115 to pull on the door or to provide leverage to manipulate the example thumb piece 120. In some examples, a geometry of the door handle (e.g., a size, a position and/or a shape, etc.) may be selected to cause the user's fingers to engage the fingerprint reader 150 when the door handle 115 is gripped naturally. Stated differently, a geometry of the door handle 115 may be tailored to induce the user to put their fingers in particular locations having the fingerprint reader 150.

Additionally, positioning of the example fingerprint reader 150 on the example rear side 140 of the example door handle 115 avoids changing an overall appearance of the example door 102.

In some examples, more than half of the example rear side 140 of the example door handle 115 includes the example fingerprint reader 150. In other examples, half or less than half of the example rear side 140 of the example door handle 115 includes the example fingerprint reader 150. In some examples, the example fingerprint reader 150 is continuous. In some examples, the example fingerprint reader 150 is discontinuous, being disposed in a number of different positions along the example rear side 140 of the example door handle 115. The positioning of the example fingerprint reader 150 on the example rear side 140 of the example door handle 115 may vary to accommodate a geometry of a particular style of example door handle 115 so as to enhance an ability of the example fingerprint reader 150 to obtain a fingerprint of a user when the user engages the example door handle 115 during normal operation.

The example fingerprint reader 150 is an electronic device used to capture a digital representation (e.g., a digital image, etc.) of a user's fingerprint(s), such a fingerprint includes one or more unique patterns of physical characteristics such as ridge geometries and minutia points (e.g., ridge end, ridge bifurcation, island, spur, delta, etc.). In a training mode, an authorized user grasps the handle so that their fingerprint(a) are read by the example fingerprint reader 150 and processed to create fingerprint data for the user. The fingerprint data includes a collection of extracted features or constructs representing the physical characteristics of the fingerprint(s). The fingerprint data for the authorized user is then stored and later made available for comparison (e.g., via pattern matching and/or minutiae point matching, etc.) to a fingerprint read during use of the example door access device 100 when the authorized user naturally engages (e.g., grasps) the example door handle 115 and, thus, touches the example rear side 140 of the example door handle 115 (e.g., to unlock the example lock 160 of the example door 102 to enter into, or exit from, the restricted area, etc.).

In some examples, the example fingerprint reader 150 includes a capacitive sensor using an array of capacitor plates (e.g., 300-600, or more, capacitor plates per inch, etc.) to image the fingerprint(s) based on different characteristic capacitive coupling between the ridges (e.g., a higher capacitance closer to the capacitor plate, etc.) and the valleys (e.g., a lower capacitance further from the capacitor plate, etc.) of the fingerprint(s). The example capacitive sensor array may be symmetric or asymmetric. A resolution of the example capacitive sensor array may include any resolution sufficient to resolve the physical characteristics (e.g., ridges, valleys, etc.) of the fingerprint(s). In some examples, the fingerprint reader 150 applies a small voltage to the user's skin to enhance the signal and contrast.

In some examples, the example fingerprint reader 150 includes an optical sensor array, or other imaging device, to image the fingerprint(s). For example, an optical sensor array may include a charge coupled device (CCD) or complementary metal-oxide-semiconductor (CMOS) device, having an array of photosensitive pixels (e.g., 300-600 photosensitive pixels per inch, etc.). In such example fingerprint reader 150, the fingerprint(s) are optically scanned (e.g., light from a light source is directed at the finger and is reflected to the CCD or CMOS sensor) to form a pixel map of the fingerprint(s) with differing degrees of dark and light corresponding to the fingerprint(s) ridges and valleys. The example optical sensor array may be symmetric or asymmetric. A resolution of the example optical sensor array may include any resolution sufficient to resolve the physical characteristics (e.g., ridges, valleys, etc.) of the fingerprint(s). For an example fingerprint reader 150 including an optical sensor array, the example fingerprint reader 150 protective glass cover, substrate, coating, or film is transparent at least at the frequency of light used to obtain the data.

In some examples, the example fingerprint reader 150 includes an array of pressure sensors (e.g., a conductive membrane over a thin film transistor (TFT) sensor or CMOS chip, etc.), with each pressure sensor in the array providing a corresponding pressure reading from the physical features of the fingerprint(s) at that point in the array (e.g., ridges exerting a first pressure, valleys exerting a second pressure less than the first pressure or no pressure, etc.) to capture the fingerprint(s). In some examples, the example fingerprint reader 150 includes an array of radio frequency (RF) sensors. An RF signal is projected toward the finger and a resulting field, reproducing the fingerprint(s) ridges and valleys, is received by the array of RF sensors. In some examples, the example fingerprint reader 150 includes an array of ultrasonic sensors. Ultrasonic signals are projected toward the finger and the reflected waveforms captured by the array of ultrasonic sensors to collect the fingerprint(s) ridges and valleys.

In some examples, a glass cover, silicon substrate, coating, or film protecting the example fingerprint reader 150 is tinted or colored to approximate a color of a door handle to which the example fingerprint reader 150 is matched to further enhance obscurement of the fingerprint reader 150 from view from a vantage of the user attempting to operate (e.g., open or close) the door 102. For example, an example fingerprint reader 150 (e.g., an ultrasonic fingerprint reader, a capacitive fingerprint reader, etc.) disposed on an example rear side 140 of an example door handle 115 that is antique bronze in color may be provided with a glass cover that is tinted or colored to approximate the antique bronze color of the door handle 115. Likewise, an example fingerprint reader 150 (e.g., an ultrasonic fingerprint reader, a capacitive fingerprint reader, etc.) disposed on an example rear side 140 of an example door handle 115 that is silver in color may be provided with a glass cover that is tinted or colored to approximate the silver color of the example door handle 115.

In some examples, the example rear side 140 of the example door handle 115 includes an example button 155 as an input device to the example door access device 100. In some examples, the example button 155 may include a push-button or a touch-button (e.g., an optical touch button, a capacitive touch button, etc.). In some examples, operation of the example button 155 activates a training mode for the example door access device 100.

The example door access device 100 of FIG. 1A also includes an example lock 160 operatively associated with an example deadbolt assembly 165 having an example deadbolt 166 that moves from an extended position in which the example deadbolt 166 engages a strike plate in a door frame, to a retracted position in which the deadbolt 166 does not engage the strike plate, permitting rotation of the example door 102 relative to the door frame about hinges provided the example latch 125 is also not engaged with a corresponding strike plate in the door frame. In some examples, the deadbolt assembly is operated from an exterior side of the door 102 by rotating an example escutcheon plate 170 about an example pin 171 to expose a keyhole, inserting a key into the keyhole and rotating the key to move the example deadbolt 166 to the retracted position. In some examples, the example lock 160 is integrated with the example latch assembly 124 and locks not only the example deadbolt 166 of the deadbolt assembly 165, but also the example latch 125 of the example latch assembly 124, so that locking and/or unlocking of the example lock 160 correspondingly locks and/or unlocks both the example latch 125 and the example deadbolt 166.

FIG. 1A also shows an example electronic device 175 (e.g., a cellular phone, a portable electronic device (PED), tablet, laptop, media player, FITBIT, smart watch, Personal Area Network (PAN) device, near field communication (NFC) device, body area network (BAN) device, etc.) communicating wirelessly via an example wireless communication pathway 176 either directly (e.g., near field communication) or indirectly (e.g., via cellular tower(s), a network, WiFi, a service, etc.). In some examples, a user is able to interact with the example door access device 100 of FIG. 1A through the example electronic device 175.

FIG. 1B shows another example door access device 100. The example door handle assembly 110 of this example includes an example door handle 115 that is rotatable about an axis of rotation. Whereas the example door handle assembly 110 of FIG. 1A uses an example thumb piece 120 to operate the example latch 125 of an example latch assembly 124, the example door handle 115 of FIG. 1B uses an example rotating knob 180 to rotate an example rotary member 185, such as a shaft disposed about an axis of rotation, to operate the example latch 125 of the example latch assembly 124. In the example of FIG. 1B, the example lock 160 is disposed within the example door handle 115. In a locked state, the example lock 160 prevents rotation of the example door handle 115 and correspondingly prevents retraction of the example latch 125 from engagement with a strike plate in a door frame.

In the example of FIG. 1B, a portion of the example rear side 140 of the example door handle 115 includes the example fingerprint reader 150. As with the example of FIG. 1A, the example fingerprint reader 150 on the example rear side 140 of the example door handle 115 is in a position of relative obscurity to advantageously avoid visually informing a prospective user of the example door 102 of the ability of the example door handle 115 to read the user's fingerprint(s) if the user naturally engages the example door handle 115 to open the example door 102. The positioning of the example fingerprint reader 150 on the example rear side 140 of the example door handle 115 also avoids changing an overall appearance of the example door 102.

In some examples, more than half of the example rear side 140 of the example door handle 115 includes the example fingerprint reader 150. For example, the example fingerprint reader 150 may be disposed in an arc covering about 240°-300°of a bottom portion and side portions of an example rear side 140 of an example door handle 115 having an example rotating knob 180. In other examples, half or less than half of the example rear side 140 of the example door handle 115 includes the fingerprint reader 150. In some examples, the example fingerprint reader 150 is unitary (e.g., a single 360° arc, as shown in the example FIG. 1B). In some examples, the example fingerprint reader 150 is discontinuous, being disposed in a number of different positions along the example rear side 140 of the example door handle 115 (e.g., a first arc of 120° on a right portion of the example rear side 140 of the rotating knob 180 and a separate, second arc of 120° on a left portion of the example rear side 140 of the knob 180, etc.). The positioning of the example fingerprint reader 150 on the example rear side 140 of the example door handle 115 may be selected to accommodate a geometry of a particular style of example door handle 115 so as to enhance an ability of the example fingerprint reader 150 to obtain the fingerprint(s) of a user when the user naturally engages the example door handle 115 and to enhance obscurement of the example fingerprint reader 150. For example, in the example above where the example fingerprint reader 150 is disposed in an arc covering about 240°-300°of a bottom portion and side portions of an example rear side 140 of an example door handle 115, the top portion of the example rear side 140 of the example door handle 115, the portion of the example door handle 115 that is the most readily visible to a user standing at the example door 102, does not include the example fingerprint reader 150.

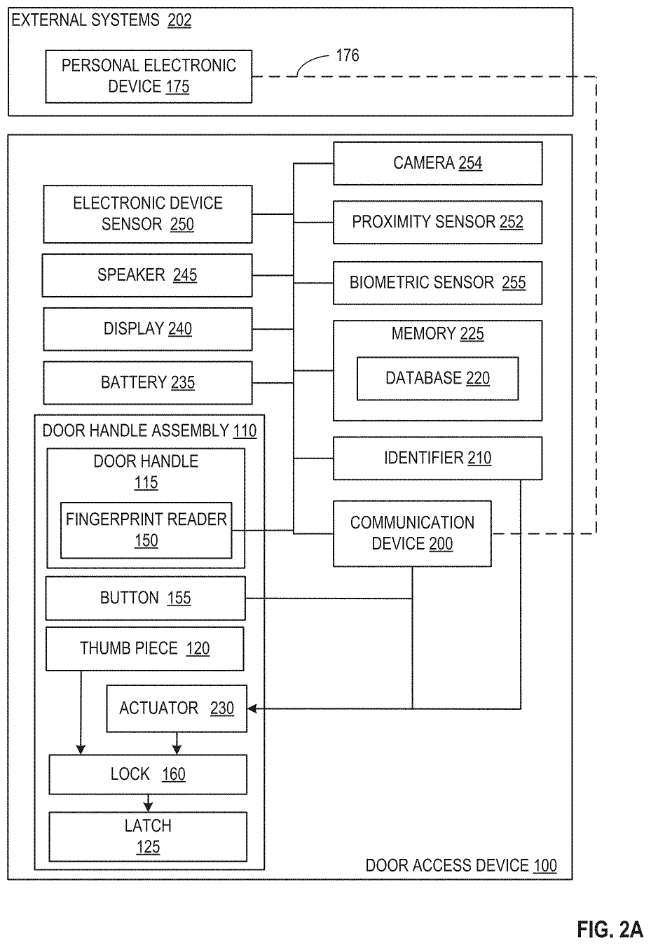

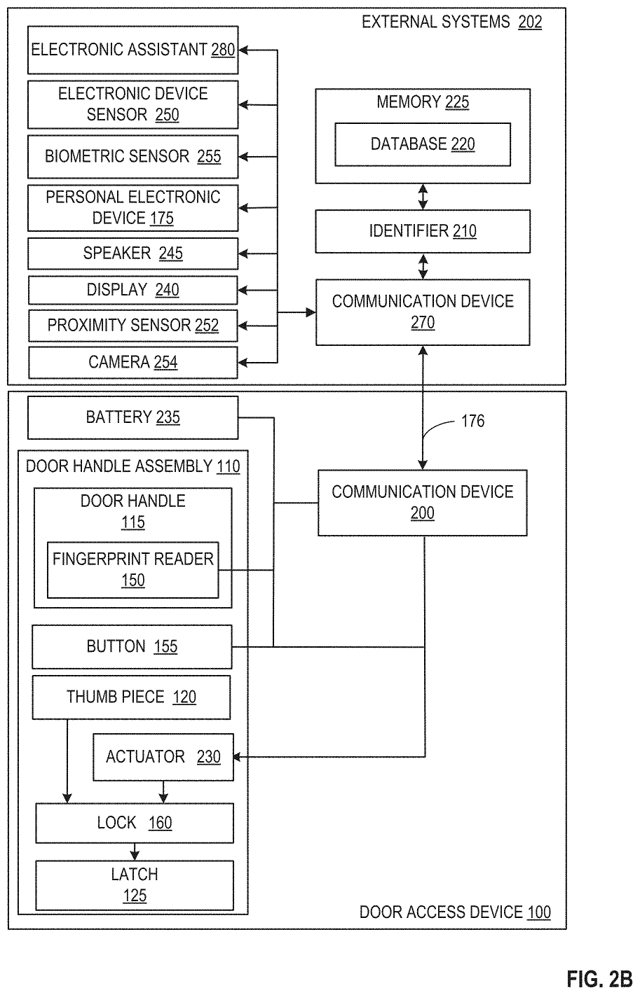

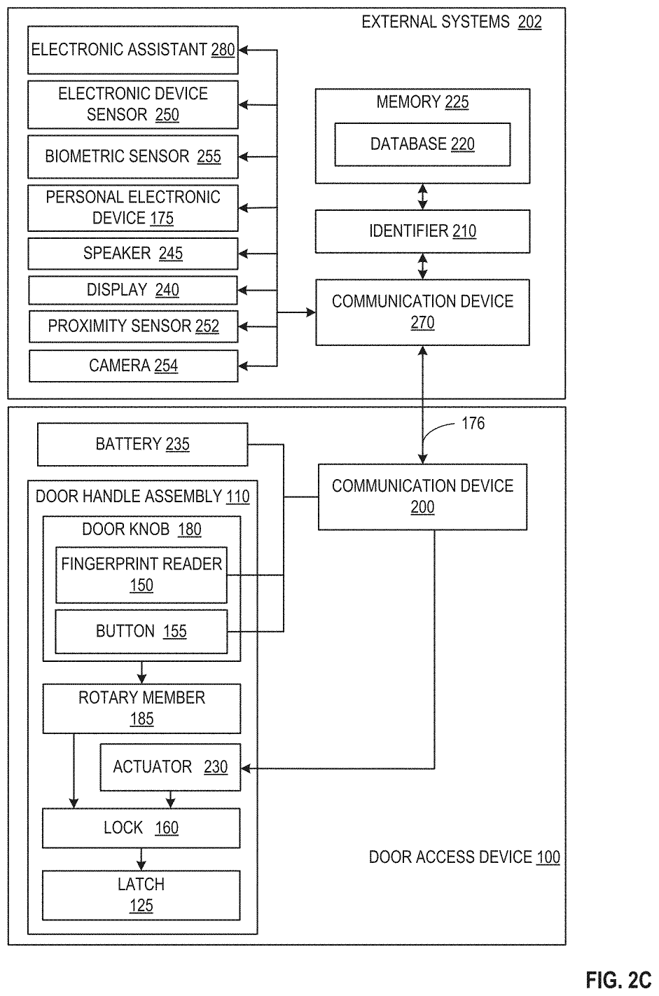

FIG. 2A is a block diagram of a first example door access system 200, including an example door access device 100 constructed in accordance with teachings of this disclosure. In the example of FIG. 2A, the first example door access device 100 includes an example communication device 201 to communicatively couple the door handle assembly 110 and fingerprint reader 150 with an example external system 202, such as a user's example personal electronic device 175, via an example wireless communication pathway 176 (e.g., cellular network, near field, Bluetooth, PAN, ZigBee, Wi-Fi, Wireless LAN, radio frequency (RF), etc.). In the example of FIG. 2A, the example door handle assembly 110 is generally as shown in FIG. 1A and includes an example door handle 115 with an example fingerprint reader 150 on the example rear side 140 of the example door handle 115 and an example thumb piece 120 operable by a user to retract the example latch 125 if the example latch 125 is not locked by the example lock 160.

The first example door access device 100 of FIG. 2A further includes an example identifier 210, an example database 220, an example memory 225, an example actuator 230, an example battery 235, an example display 240, an example speaker 245, an example electronic device sensor 250, an example proximity sensor 252 and an example biometric sensor 255.

The example identifier 210 is to identify a user of the example door access device 100 and to take action based on a determination that the user is an authorized user or a determination that the user is not an authorized user.

The example database 220 is located in the memory 225 and includes information used to identify a user. This information may include, for example, fingerprint data for the user, biometric data for the user (e.g., vocalization data, facial recognition data, retinal/iris data, etc.) and/or example personal electronic device 175 data for the user (e.g., a smart phone Unique Device ID (UDID), media access control address (MAC address), etc.). The example memory 225 of FIG. 2A further includes computer readable instructions to implement the first example door access device 100 including any or all of the example button 155, the example communication device 201, the example identifier 210, the example actuator 230, the example display 240, the example speaker 245, the example electronic device sensor 250, the example proximity sensor 252 and/or the example biometric sensor 255.

The example actuator 230 is disposed in the example door 102 to act on the example lock 160 and/or the example latch 125 to change a state of the example lock 160 and/or the example latch 125 to permit retraction of the example latch 125 from engagement with a door frame strike plate. The actuator 230 is responsive to depression of the example thumb piece 120 (e.g., FIGS. 1A, 2A), rotation of the example door knob 180 (e.g., FIGS. 1B, 2C), or manipulation of door hardware (e.g., pulling on the example door handle 115) by the user. In some examples, the example actuator 230 is a linear motion actuator, a micro linear servo, a solenoid, or a shape memory alloy (SMA), to move a control pin or control lever, or the like, from a first state (e.g., engaged to lock the example lock 160 and/or the example latch 125, etc.) to a second state (e.g., disengaged to unlock the example lock 160 and/or disengage the example lock 160 from the example latch 125, etc.).

The example battery 235 provides power to the electronics in the door access device 100. The example battery 235 may include, for example, a battery pack (e.g., lithium ion batteries, a Li-ion polymer batteries, lithium polymer (LiPo) batteries, etc.), one or more CR 123A lithium batteries, one or more 18650 batteries, one or more 9V batteries, or one or more AA batteries. In some examples, the example battery 235 provides power to the example fingerprint reader 150, the example button 155, the example communication device 201, the example identifier 210, the example display 240, the example speaker 245, the example electronic device sensor 250, the example proximity sensor 252 and/or the example biometric sensor 255. In some examples, one or more solar cells are provided to provide power to the example fingerprint reader 150, the example button 155, the example communication device 201, the example identifier 210, the example battery 235, the example display 240, the example speaker 245, the example electronic device sensor 250, the example proximity sensor 252 and/or the example biometric sensor 255.

The example display 240 includes, in some examples, a liquid crystal display (LCD) or a thin film transistor (TFT) display, and may include a touch screen. In some examples, the example display 240 is disposed on the example door handle assembly 110, on the example door 102, or adjacent the example door 102 to provide information to a user of the example door access device 100 and/or receive inputs from the user. In some examples, the example display 240 is disposed within a restricted area regulated by the example door access device 100 and serves to display information (e.g., an image of a person at the door, etc.) to an authorized user within the restricted area.

The example speaker 245 includes, in some examples, a micro-speaker or a piezo audio speaker to provide information to a user of the example door access device 100. In some examples, the example speaker 245 is disposed within a restricted area regulated by the example door access device 100 and serves to output audio information (e.g., a tone, a message, a voice, etc.) to/from an authorized user within the restricted area.

In some examples, the example electronic device sensor 250 serves as a wireless access point (WAP) for the example personal electronic device 175 (e.g., a client device, etc.). In some examples, the example electronic device sensor 250 is paired with an example proximity sensor 252 to activate the example electronic device sensor 250 when a user approaches the example door 102. When activated, the example electronic device sensor 250 scans for wireless devices, connects to a sensed wireless device (e.g., the example personal electronic device 175) via an example wireless communication pathway 176 and authenticates the sensed wireless device, such as through a keyed authentication, an open authentication, a shared key authentication, Bluetooth connection, or the like. In some examples, the example personal electronic device 175 is set to automatically recognize and connect to the example electronic device sensor 250.

The example biometric sensor 255 is separate from the example fingerprint reader 150. In the example of FIG. 2A, area sensors provide an additional measure of user identification. The example biometric sensor 255 may include, for example, a facial recognition imaging system, a retinal/iris scanner and/or a voice recognition system. The example biometric sensor 255 may also be used, for example, to provide biometric information directly to an authorized user as part of a notification process. For example, an image of, and/or a vocalization of, an unauthorized user at the example door 102 may be transmitted to the example personal electronic device 175 of an authorized user or to an example display 240 accessible to the authorized user.

FIG. 2B is a block diagram of a second example door access system 200, including an example door access device 100 constructed in accordance with teachings of this disclosure. In FIG. 2B, the example identifier 210, the example database 220, the example memory 225, the example actuator 230, the example display 240, the example speaker 245, the example electronic device sensor 250, the example proximity sensor 252 and the example biometric sensor 255 are external systems 202 to the second example door access device 100. For example, the example display 240, the example speaker 245, the example electronic device sensor 250, the example proximity sensor 252 and the example biometric sensor 255 are disposed in a housing, separate from the second example door access device 100 (e.g., disposed above an example door 102, disposed to a right or left side of an example door 102, etc.) and the example identifier 210, the example database 220 and the example memory 225 are disposed in a location remote from the example door 102 (e.g., implemented by a server or a computer in an area different location than the second example door access device 100, etc.).

In some examples, two displays 240 and two speakers 245 are employed to enable communication with a user of the door, with one speaker and display in or in the vicinity of the door access device 100 and the other speaker and display disposed in a restricted area (e.g., home, business, apartment, etc.) to provide access to a user of the restricted area. In another example, the example display 240 and the example speaker 245 are implemented by a display and an internal speaker of an example personal electronic device 175 (e.g., a smart phone, etc.) carried by a person controlling access to the restricted area (e.g., an owner or designee, etc.) to provide notification of the presence of and/or identity of the user. FIG. 2B also shows, as an example external system 202, an example electronic assistant 280, such as Google Home or Amazon Echo, disposed in the restricted area. The example electronic assistant 280 may be used to provide notifications and/or information regarding the person at the door and/or to operate the door access device 100.

FIG. 2C is a block diagram of a third example door access system 200, including an example door access device 100 constructed in accordance with teachings of this disclosure. In FIG. 2C, the example door handle assembly 110 includes an example door knob 180 to rotate the example rotary member 185 to retract the example latch 125 if not prevented by the example lock 160. The example of FIGS. 2A, 2B and/or 2C include several similar structures. In the interest of brevity, descriptions of like structures are not repeated in connection with FIGS. 2B and 2C. Instead, the interested reader is referred to the discussion of FIG. 2A for a complete description of the structure. Like reference numerals are used to refer to like structure to facilitate this process.

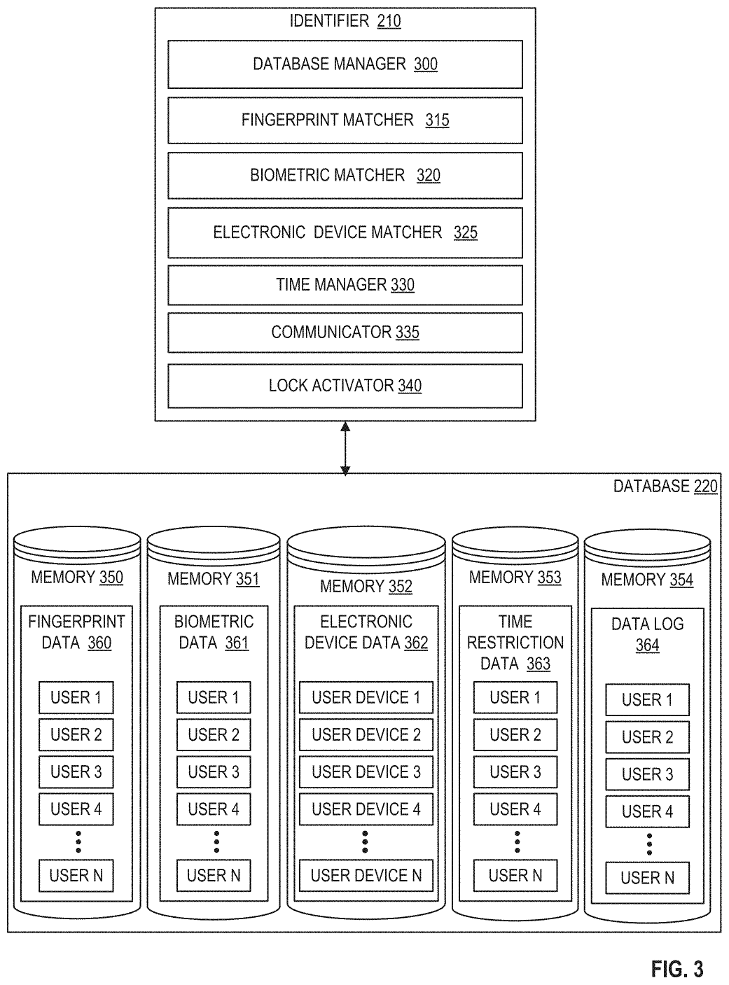

FIG. 3 is a block diagram of an example identifier 210 constructed in accordance with teachings of this disclosure to be used with any of the example door access devices 100 depicted in FIGS. 1A-2C. The identifier 210 may be implemented by, for example, software existing on a processor within, for instance, a building protected by the door 102. For example, the identifier 210 may be implemented by software executed by a server or other computing device located within the restricted area and/or at a remote facility. Alternatively, the identifier 210 may be implemented by an IOT (Internet of Things) appliance plugged into a source of commercial power within the restricted area. In this example, the example identifier 210 includes an example database manager 300, an example fingerprint matcher 315, an example biometric matcher 320, an example electronic device matcher 325, an example time manager 330, an example communicator 335 and an example lock activator 340. The example identifier 210 communicates with the example database 220. The database 220 of the example is resilient in free portions of memory 350 which stores example fingerprint data 360 for authorized users, memory 351 which stores example biometric data 361 for authorized users, memory 352 which stores example electronic device data 362 for authorized users, and memory 352 which stores example time restriction data 363 for authorized users. The memories 350-354 may be located in the same or different memory devices and the data may be arranged in any desired format. In some examples, the example database 220 only includes the example fingerprint data 360. In some examples, the example database 220 includes the example fingerprint data 360 and one or more of the example biometric data 361, the example electronic device data 362 and/or the example time restriction data 363. The example fingerprint data 360, the example biometric data 361, the example electronic device data 362 and/or the example time restriction data 363 includes data relating to one or more users.

The example database manager 300 is to operate as an interface between the user, or requesting application programs (e.g., a smart phone application on the example personal electronic device 175, etc.), and the example database 220. The example database manager 300 is to ensure that data is organized and accessible to the example identifier 210.

The example fingerprint matcher 315 attempts to match a fingerprint read by the example fingerprint reader 150 of the example door access device 100 with a fingerprint in the example fingerprint data 360 of the example database 220. The example fingerprint data 360 includes, for each authorized user, fingerprint data for one or more fingers stored by the authorized user during enrollment via the example fingerprint reader 150 or via another electronic device (e.g., a fingerprint imaging application on the example personal electronic device 175, etc.). The example fingerprint data 360 includes, for example, image data or features (minutiae) contextually extracted from the image data permitting the example fingerprint matcher 315 to validate a later read fingerprint using a pattern-based matching (e.g., pixel by pixel comparison of a fingerprint in relation to the fingerprint data, adjusted for positional errors or displacement) and/or a minutiae-based matching (e.g., a comparison of a location and direction of minutiae extracted from the fingerprint and a location and direction of minutiae of the fingerprint data). In some examples, the example fingerprint matcher 315 comports with one or more of past, present or future standards or formats for fingerprint image-based data interchange (e.g., finger pattern based interchange format, finger minutiae format for data interchange, etc.).

The example biometric matcher 320 attempts to match biometric data of a user of the example door access device 100 sensed by the example biometric sensor 255 with example biometric data in the example biometric data 361 of the example database 220. The example biometric data 361 includes, for each authorized user, biometric data (e.g., facial recognition data, iris/retinal data, vocalization data, etc.) stored during enrollment of the authorized user data into the example database 220. The biometric data includes data or data constructs of characteristics (e.g., physical facial landmarks, relative positions or sizes/shapes of the physical facial landmarks, vocal patterns, etc.) from which later comparisons can be made. In some examples, the example biometric matcher 320 uses an imaging device (e.g., camera 254) to obtain an image of the authorized user, to which image facial recognition techniques may be applied. In some examples, a facial recognition algorithm includes a geometric recognition algorithm to analyze physical landmarks or a photometric algorithm to distill image data from the example biometric sensor 255 into values that can be compared to corresponding values in the example biometric data 361 to determine variances. In some examples, the example biometric matcher 320 uses eigenfaces, discriminant analysis (DA), linear discriminant analysis, recursive Fisher linear discriminant, principal component analysis (PCA), independent component analysis (ICA), kernel methods, or hidden Markov models (HMM).

The example electronic device matcher 325 attempts to match data of the example personal electronic device 175 of an authorized user of the example door access device 100, received by the example electronic device sensor 250, with the example electronic device data 362 of the example database 220. The example electronic device data 362 includes, for each user, UDID data or MAC address data, or the like, from an authorized user's example personal electronic device 175.

The example time manager 330 attempts to determine if any time limitations have been imposed on an authorized user's access to or from the restricted area, via the example door access device 100. The example time restriction data 363 in the example memory 353 of the example database 220 includes any pertinent time restrictions imposed on a user. For example, a home owner (e.g., authorized user 1) stores in the example time restriction data 363 for a housekeeper (e.g., authorized user 4), a permissible access time starting at 11:00 AM on every Tuesday and ending at 4:00 PM on every Tuesday, to permit multiple entries by the housekeeper during the allotted time. If the housekeeper arrives at any time outside of the permissible access time set for the user in the example time restriction data 363, the example door access device 100 will not permit entry.

The example communicator 335 facilitates communication between the example identifier 210 and the example fingerprint reader 150, the example database 220, the example actuator 230, the example biometric sensor 255, and/or the example electronic device sensor 250. The communicator 335 may be implemented by, for example, a transceiver of any type.

The example lock activator 340 causes the example actuator 230 to unlock the example lock 160 following satisfaction of one or more conditions. In some examples, the example identifier 210 must identify a match between the fingerprint(s) read by the example fingerprint reader 150 and the fingerprint(s) stored in the example fingerprint data 360 to satisfy one such condition. In some examples, the example identifier 210 must identify a match between a time of attempted access and a set of authorized times for the user stored in the example time restriction data 363 to satisfy one such condition. In some examples, the example identifier 210 must identify a match between a biometric data read by the example biometric sensor 255 and the example biometric data 361 to satisfy one such condition. In some examples, the example identifier 210 must identify a match between the example personal electronic device 175 detected by the door access device 100 and an electronic device in the example electronic device data 362 to satisfy one such condition. In some examples, the one or more conditions required to cause the example lock activator 340 to unlock the example lock 160 via the example actuator 230 includes a combination of two or more of (e.g., all of) the above conditions.

The example lock activator 340 causes the example actuator 230 to change and/or enforce a state of the example lock 160 following satisfaction of one or more conditions or, alternatively, failure to satisfy one or more conditions. In some examples, the example lock activator 340 causes the example actuator 230 to lock the example lock 160 following a determination by the example identifier 210 that a match is not identified between a fingerprint read by the example fingerprint reader 150 and a fingerprint in the fingerprint data. In some examples, the example lock activator 340 causes the example actuator 230 to lock the example lock 160 following a determination by the example identifier 210 that a match is not identified between a time of attempted access and a set of authorized times for the user stored in the example time restriction data 363. In some examples, the example lock activator 340 causes the example actuator 230 to lock the example lock 160 following a determination by the example identifier 210 that a match is not identified between biometric data read by the example biometric sensor 255 and the example biometric data 361. In some examples, the example lock activator 340 causes the example actuator 230 to lock the example lock 160 following a determination by the example identifier 210 that a match is not identified between the example personal electronic device 175 detected by the door access device 100 and an electronic device in the example electronic device data 362.

In the example of FIG. 3, the example database 220 includes an example memory 354 storing an example data log 364. In some examples, the example data log 364 includes logged information identifying time(s) of user entry and/or exit through the door, notification information, identifying time(s) of entry attempt information and/or identifying time(s) of exit attempt information.

While an example manner of implementing the example identifier 210 is set forth in FIG. 3, one or more of the elements, processes and/or devices illustrated in FIG. 3 may be combined, divided, re-arranged, omitted, eliminated and/or implemented in any other way. For example, the example database manager 300, the example fingerprint matcher 315, the example biometric matcher 320, the example electronic device matcher 325, the example time manager 330, the example communicator 335 and/or the example lock activator 340 of FIG. 3 may be implemented by hardware, software, firmware and/or any combination of hardware, software and/or firmware. Thus, for example, any or all of the example database manager 300, the example fingerprint matcher 315, the example biometric matcher 320, the example electronic device matcher 325, the example time manager 330, the example communicator 335 and/or the example lock activator 340 of FIG. 3 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example database manager 300, the example fingerprint matcher 315, the example biometric matcher 320, the example electronic device matcher 325, the example time manager 330, the example communicator 335 and/or the example lock activator 340 are hereby expressly defined to include a non-transitory computer-readable storage device or storage disk such as a memory, a digital versatile disk (DVD), a compact disk (CD), a Blu-ray disk, a flash memory, etc. storing the software and/or firmware. Further still, the example database manager 300, the example fingerprint matcher 315, the example biometric matcher 320, the example electronic device matcher 325, the example time manager 330, the example communicator 335 and/or the example lock activator 340 of FIG. 3 may include one or more elements, processes and/or devices in addition to, or instead of, those illustrated in FIGS. 1A-3, for example, and/or may include more than one of any or all of the illustrated elements, processes and devices.

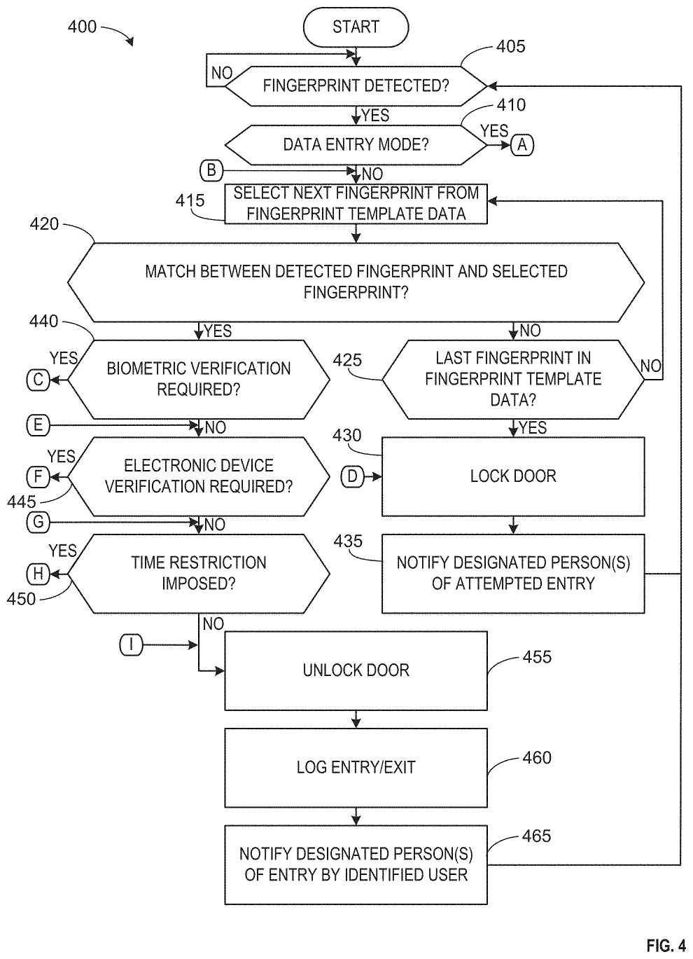

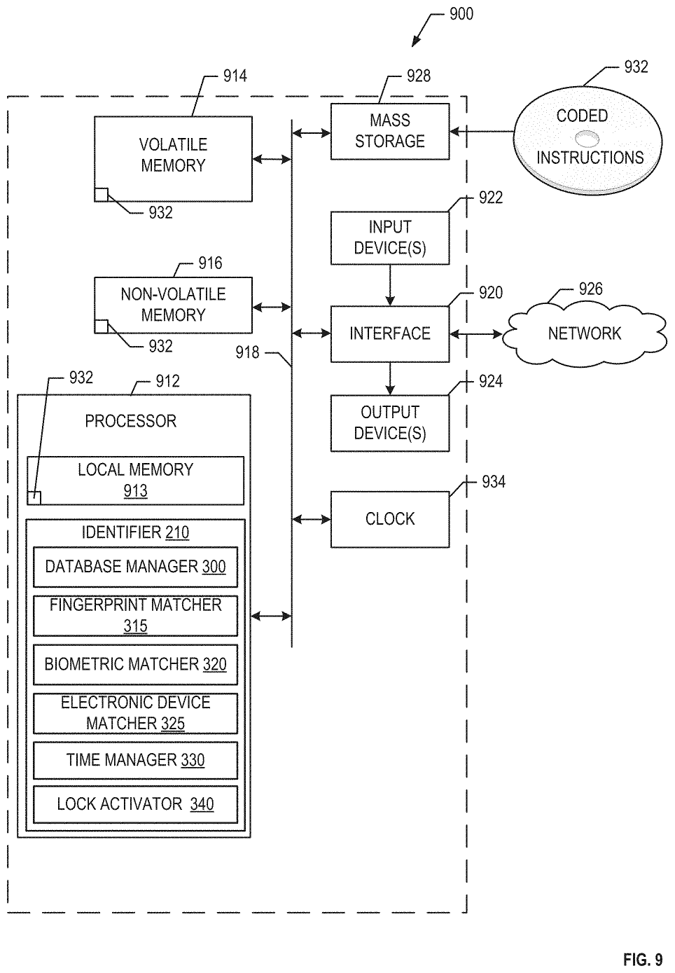

An example flowchart representing example machine readable instructions for implementing the example identifier 210 of FIG. 3 is shown in FIGS. 4-8. In the example of FIGS. 4-8, the machine-readable instructions are r for execution by one or more processors, such as the example processor platform 900 discussed below in connection with FIG. 9. The program may be embodied in software stored on a non-transitory computer-readable storage medium such as a CD-ROM, a floppy disk, a hard drive, a digital versatile disk (DVD), a Blu-ray disk, a cloud-based server memory, a remote computer memory, or a memory associated with the example processor 912, but the entire program and/or parts thereof could alternatively be executed by a device other than the example processor 912 and/or embodied in firmware or dedicated hardware. Further, although the example program is described with reference to the flowcharts illustrated in FIGS. 4-8, many other methods of implementing the example identifier 210 may alternatively be used. For example, the order of execution of the blocks in FIGS. 4-8 may be changed, and/or some of the blocks described may be changed, eliminated, and/or combined.

As mentioned above, the example machine readable instructions shown in FIGS. 4-8 for implementing the example identifier 210 disclosed herein, may be implemented using coded instructions (e.g., computer and/or machine readable instructions) stored on a non-transitory computer and/or machine readable medium, wherever located, such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used (e.g., as the transition term in a preamble of a claim), it is open-ended in the same manner as the term “comprising” is open ended.

The example program 400-800 of FIGS. 4-8 begins at block 405 where the example fingerprint reader 150 determines if a fingerprint is detected. If no fingerprint is detected (block 405=“NO”), control loops back to block 405. If a fingerprint is detected (block 405=“YES”), control passes to block 410.

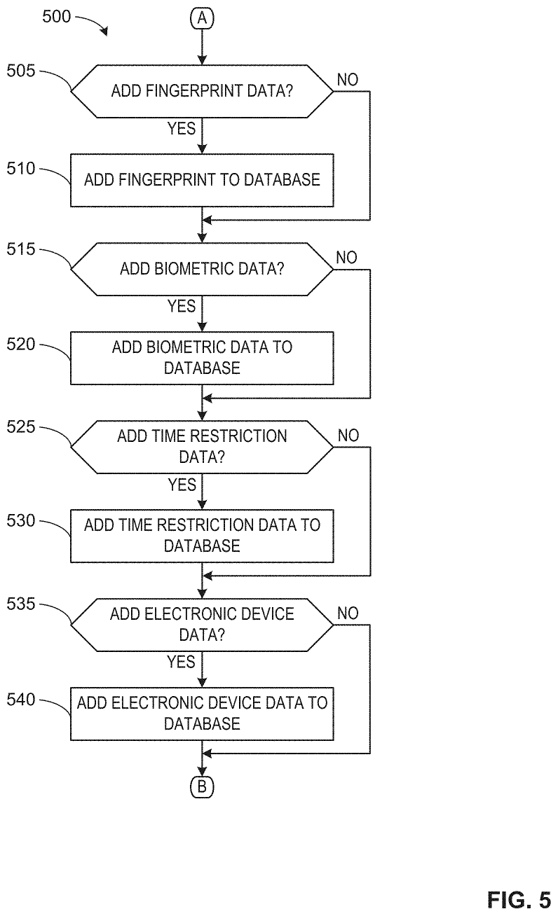

At block 410, the example database manager 300 determines if a data entry mode is to be entered, such as a door access device 100 training mode in which a fingerprint detected at block 405 is to be stored in the example fingerprint data 360 of the example database 220. In some examples, an authorized user instructs the door access device 100 to enter a data entry mode via input of a data entry mode code in a door access device 100 setup application in the user's example personal electronic device 175, the code being communicated from the example personal electronic device 175 to the example communication device 201 of the example door access device 100 via the example communication pathway 176. If a data entry mode is not to be entered (block 410=“NO”), control passes back to block 415. If a data entry mode is to be entered (block 410=“YES”), control passes to example routine 500 of FIG. 5.

At block 415, the example database manager 300 selects a fingerprint from the example fingerprint data 360 stored in the example memory 350 of the example database 220 to compare with the fingerprint detected at block 405.

At block 420, the example fingerprint matcher 315 compares the fingerprint detected at block 405 to the fingerprint selected from the example fingerprint data 360 of the example database 220 to determine if the detected fingerprint and the selected fingerprint match. As noted above, this comparison may use any manner of comparison of fingerprint data such as, but not limited to, a correlation-based or a pattern-based technique. If a match is not found between the detected fingerprint and the selected fingerprint (block 420=“NO”), control passes to block 425. If a match is found between the detected fingerprint and the selected fingerprint (block 420=“YES”), control passes to block 440.

At block 425, following an unsuccessful match between the fingerprint detected at block 405 and the fingerprint selected from the example fingerprint data 360 at block 420, the example database manager 300 determines whether the fingerprint previously selected at block 415 was the last fingerprint in the example fingerprint data 360. If the fingerprint selected at block 415 was not the last fingerprint in the example fingerprint data 360 (block 425=“NO”), control passes back to block 415 where a next fingerprint in the example fingerprint data 360 is selected for comparison to the detected fingerprint at block 420. If the selected fingerprint was the last fingerprint in the example fingerprint data 360 (block 425=“YES”), control passes to block 430.

At block 430, since no fingerprint in the example fingerprint data 360 was found to match the fingerprint detected at block 405, the detected fingerprint corresponds to an unauthorized user and the example lock activator 340 sends a control signal to the example actuator 230 to lock the example door 102 in response to the failure to match the fingerprint read by the fingerprint reader with a fingerprint in the fingerprint data. Thus, if a homeowner inadvertently leaves the front door to the home unlocked and an unauthorized user (e.g., a stranger) engages the example door handle 115 to open the unlocked front door, the door access device 100 will automatically lock the example lock 160 to prevent the unauthorized user from opening the door. Control then passes to block 435.

At block 435, the example communicator 335 notifies designated person(s) of the attempted entry. This notification can be sent to, for example, the personal electronic device 175, the speaker 245, the display 240 and/or the electronic assistant 280. Following such notification at block 435, control then passes back to block 405 for continued monitoring.

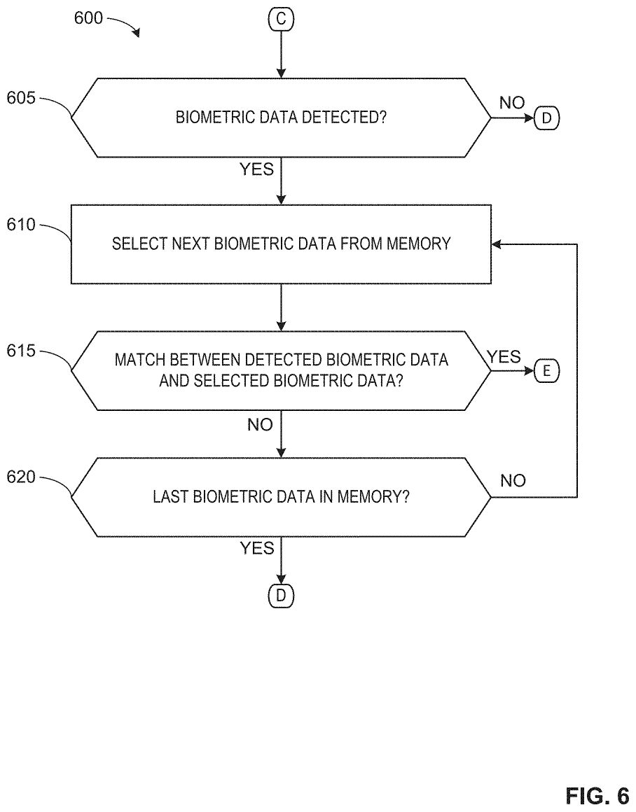

At block 440, following a successful match between the fingerprint detected at block 405 and the fingerprint selected from the example fingerprint data 360 at block 420, the identifier 210 then determines whether additional verification is required. At block 440, the identifier 210 determines whether a biometric verification is required. If a biometric verification is required (block 440=“YES”), control passes to the biometric matcher 320 as reflected in the routine 600 shown in FIG. 6. If the biometric verification performed by the example routine 600 is successful, control returns to block 445. If a biometric verification is not required (block 440=“NO”), control passes directly to block 445 without executing the routine of FIG. 6.

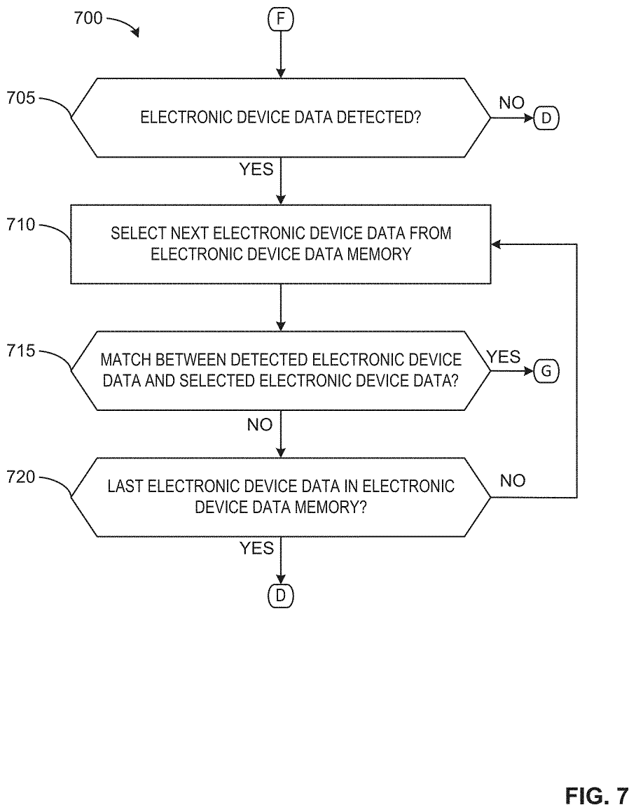

At block 445, the identifier 210 determines whether an electronic device verification is required. If an electronic device verification is required (block 445=“YES”), control passes to the example electronic device matcher 325 as shown in routine 700 shown in FIG. 7. If the electronic device verification performed by the electronic device matcher 325 is successful, control returns to block 450. If an electronic device verification is not required (block 445=“NO”), control passes to block 450.

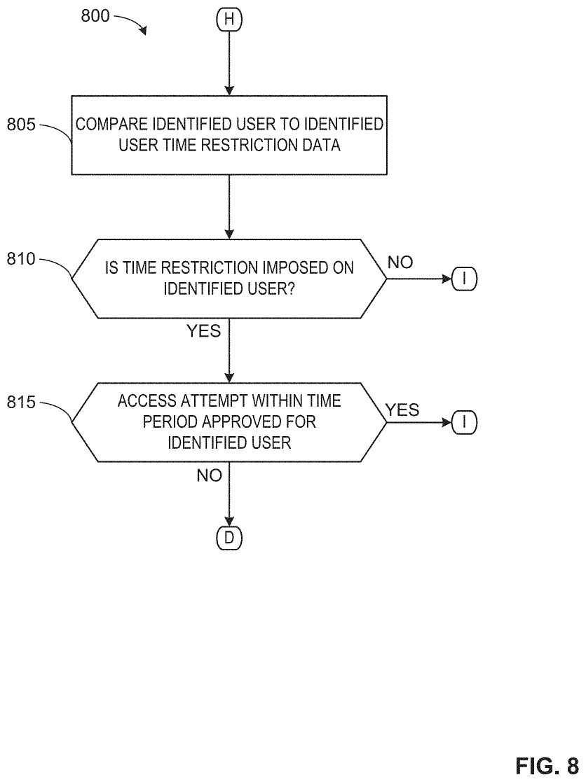

At block 450, the time manager 330 determines whether a temporal limitation has been imposed on the now-validated user. If a time restriction has been imposed on the user (block 450=“YES”), control passes to the time manager 330 as shown in the example routine 800 of FIG. 8. If the time restriction verification performed by the time manager 330 is successful, control returns to block 455. If a time restriction has not been imposed on the user (block 450=“NO”), control passes to block 455.

At block 455, following validation of the detected fingerprint as belonging to an authorized user, via a matching of the detected fingerprint with a fingerprint in the example fingerprint data 360, and without other preconditions blocking passage (e.g., biometric verification at block 440, electronic device verification at block 445, or time restrictions imposed at block 450), the lock activator 340 then unlocks the example door 102. In some examples, the unlocking of the example door 102 is via actuation of the example actuator 230 to unlock the example lock 160 of the example door access device 100 in response to a match between the fingerprint read by the example fingerprint reader 150 and a fingerprint in the example fingerprint data 360. From block 455, control passes to block 460.

At block 460, the database manager 300 logs the passage of the user (e.g., an entry into an authorized area, an exit from an authorized area, etc.). In some examples, the entry or exit of the user is logged in the example data log 364 in the example database 220 along with a time and/or a date of occurrence. From block 460, control passes to block 465.

At block 465, the communicator 335 notifies designated person(s) of the entry or exit logged at block 460. This notification may be sent to, for example, the personal electronic device 175, the speaker 245, example display 240, or the electronic assistant 280. Following such notification at block 435, control passes back to block 405 for continued monitoring.

Turning to FIG. 5, control passes to block 505 from block 410 when a data entry mode is entered by a user instruction to the example door access device 100. In the data entry mode, a user may update, for example, the example fingerprint data 360, the example biometric data 361, the example electronic device data 362 and/or the example time restriction data 363. In some examples, updates to the example fingerprint data 360 or the example biometric data 361 use a sensor operatively connected to the example personal electronic device 175 or another computer, such as using a digital imaging device of the example personal electronic device 175 or computer to obtain biometric data (e.g., a facial scan and extraction of biometric data therefrom, an optical fingerprint scan, a capacitive fingerprint scan, etc.).

At block 505, the example identifier 210 determines if the detected fingerprint from block 405 is to be added to the example fingerprint data 360 in example memory 350. If the result of block 505 is “YES,” the detected fingerprint is added to the example fingerprint data 360 (block 510). If the result of block 505 is “NO,” control passes to block 515.

At block 515, the identifier 210 determines if biometric data is to be added to the example biometric data 361 in the example memory 351. If the result of block 515 is “YES,” the biometric data is obtained using the example biometric sensor 255 and the biometric data is added to the example biometric data 361 in example memory 351 (block 520). If the result of block 515 is “NO,” control passes to block 525.

At block 525, the example routine 500 determines if time restriction data is to be added to the example time restriction data 363 in the example memory 353 responsive to a user instruction to the example door access device 100 via the example personal electronic device 175 or other input device. If the result of block 525 is “YES,” time restriction data is entered by the user via a data input device of the example personal electronic device 175 or computer used to access the example routine via the example communication device(s) 200, 270 and stored in the example time restriction data 363 at block 530. For example, if a housekeeper has a fingerprint stored in the example fingerprint data 360, but is to be rescheduled from a first day and/or time to a second day and/or time, the user (e.g., the homeowner, etc.) can selectively alter the time restriction data for the housekeeper to correspond to the second day and/or time. If the result of block 525 is “NO,” control passes to block 535.

At block 535, the example identifier 210 determines if electronic device data is to be added to the example electronic device data 362 in the example memory 352. If the result of block 535 is “YES,” electronic device data is entered by the user via a data input device of the example personal electronic device 175 or computer and stored in the example electronic device data 362 (block 540). If the result of block 535 is “NO,” control passes to block 415 of example routine 400.

Example routine 600 in FIG. 6 is an example implementation of the biometric matcher 320 of FIG. 3. At block 605, the biometric matcher 320 determines whether biometric data is detected. In some examples, the example door access device 100 determines whether biometric data is detected via the example biometric sensor 255 (e.g., an imaging device, etc.) of the door access device 100 or of an example external system 202. If the result of block 605 is “NO,” control passes to block 430 of FIG. 4 where a control signal is output to the example actuator 230 to lock the example door 102, and control passes to block 435.

If the result of block 605 is “YES,” control passes to block 610 where a next biometric data in the example biometric data 361 is selected for comparison to the detected biometric data.

At block 615, the biometric matcher 320 determines if there is a match between the selected biometric data from the example biometric data 361 and the detected biometric data. In some examples, the selected biometric data includes facial recognition data and the detected biometric data includes facial landmarks of a user at the example door 102 seeking to open the example door 102. For example, the example biometric matcher 320 uses a geometric recognition algorithm to analyze correspondence between the physical landmarks in the detected biometric data and physical landmarks in the selected biometric data from the example biometric data 361. If there is a match between the selected biometric data from the example biometric data 361 and the detected biometric data (block 615=“YES”), control passes to block 445 of FIG. 4.

If the selected biometric data from the example biometric data 361 does not match the detected biometric data (block 615=“NO”), control passes to block 620. At block 620, the biometric matcher 320 determines if the selected biometric data was the last biometric data in the example biometric data 361. If the selected biometric data was the last biometric data in the example biometric data 361 (block 620=“YES”), control passes to block 430 of FIG. 4. If the selected biometric data was not the last biometric data in the example biometric data 361 (block 620=“NO”), control passes to block 610 and a next biometric data is selected from memory 351 to compare to the detected biometric data.

Example routine 700 in FIG. 7 is an example implementation of the electronic device matcher 325 of FIG. 3. At block 705, the electronic device matcher 325 determines whether electronic device data is detected. In some examples, the electronic device matcher 325 determines whether electronic device data is detected via the example electronic device sensor 250 of the example door access device 100 or of an example external system 202. If the result of block 705 is “NO,” control passes to block 430 of FIG. 4. If the result of block 705 is “YES,” control passes to block 710 where the next electronic device data in the example electronic device data 362 is selected for comparison to the detected electronic device data.

At block 715, the electronic device matcher 325 determines if there is a match between the selected electronic device data from the example electronic device data 362 and the detected electronic device data. For example, the example electronic device sensor 250 obtains UDID data or MAC address data, or the like, from the example personal electronic device 175 and the electronic device matcher 325 compares that sensed electronic device data to the selected electronic device data from the example electronic device data 362. If there is a match between the selected electronic device data and the detected electronic device data (block 715=“YES”), control passes to block 450 of FIG. 4.

If the selected electronic device data from the example electronic device data 362 does not match the detected example personal electronic device 175 data (block 715=“NO”), control passes to block 720. At block 720, the electronic device matcher 325 determines if the selected electronic device data was the last electronic device data in the example electronic device data 362. If the selected electronic device data was the last electronic device data in the example electronic device data 362 (block 720=“YES”), control passes to block 430 of FIG. 4. If the selected electronic device data was not the last electronic device data in the example electronic device data 362 (block 720=“NO”), control passes to block 710 and a next electronic device data is selected from example memory 352 to compare to the detected electronic device data.

Example routine 800 in FIG. 8 is an example of an implementation of the time manager 330 of the example door access device 100. At block 805, the time manager 330 determines whether a user already identified to the example door access device 100, via a fingerprint match, a biometric data match and/or an electronic device match, is permitted to open the example door 102 at the particular time at which the user engages the example door 102. At block 805, the user's identity is compared to example time restriction data 363 in example memory 353.

At block 810, the time manager 330 determines if a time at which the user engages the example door access device 100 is denoted as a restricted time for the user. If the result of block 810 is “NO,” control passes to block 455 of FIG. 4 and the door is unlocked (block 455). If the result of block 810 is “YES,” control passes to block 815. At block 815, the time manager 330 determines if the access attempt by the user is within an access time period approved for the identified user. If the result of block 815 is “YES,” control passes to block 455 of FIG. 4 and the door is unlocked. However, if the result of block 815 is “NO,” control passes to block 430 of FIG. 4.

To illustrate an example use of example time restriction data 363, a parent caring for a toddler may set time restriction data 363 for their toddler, an authorized user, to ensure that they do not leave the house unsupervised between a designated start time and end time. If the toddler engages the example door handle 115 on an interior side of the example door 102 during that designated time, the example door access device 100 would read the fingerprint of the toddler using the example fingerprint reader 150 on the example rear surface 140 of the example door handle 115 on the interior side of the example door 102, match the read fingerprint(s) to the toddler's fingerprint data in the example fingerprint data 360 using the example identifier 210, and engage the example lock activator 340 to lock the example door 102 to prevent the unsupervised exit of the toddler. Additionally, via block 435 of FIG. 4, the parent will be notified of the attempted exit from the house by the toddler (e.g., via the example personal electronic device 175, the example electronic assistant 280, etc.). Further, the designation of time restriction data 363 may be selective to a direction of ingress or egress.

As noted above, FIG. 9 is a block diagram of an example processor platform 900 capable of executing the example instructions of FIGS. 4-8 to implement the example identifier 210 of FIG. 3 and/or the example access device of FIGS. 1-2C. The processor platform 900 may be implemented by a server, a desktop computer, a laptop computer, a terminal, a mobile device (e.g., a tablet computer, such as an iPad™), a dedicated device, an IOT device, or any other type of computing device.

The processor platform 900 of the illustrated example includes a processor 912. The processor 912 of the illustrated example is hardware. For example, the processor 912 can be implemented by integrated circuits, logic circuits, microprocessors or controllers from any desired family or manufacturer. In the example of FIG. 9, the processor 912 implements the identifier 210. As such, it implements the database manager 300, the fingerprint matcher 315, the biometric matcher 320, the electronic device matcher 325, the time manager 330, and the lock activator 340.

The processor 912 of the illustrated example includes a local memory 913 (e.g., a cache). The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory (e.g., 914, 916) is controlled by a memory controller.

The processor platform 900 of the illustrated example also includes an interface circuit 920. The interface circuit 920 may be implemented by any type of interface standard, such as an Ethernet interface, a universal serial bus (USB), and/or a PCI express interface.

In the illustrated example, input device(s) 922 are connected to the interface circuit 920. The input device(s) 922 permit(s) a user to enter data and commands into the processor 912. The input device(s) can be implemented by, for example, an audio sensor, a microphone, a camera (still or video) (see, e.g., camera 254 in FIGS. 2A-2C), a keyboard, a button, a mouse, a touchscreen, a track-pad, a trackball, isopoint and/or a voice recognition system.

One or more output devices 924 are also connected to the interface circuit 920 of the illustrated example. The output devices 924 can be implemented, for example, by display devices (e.g., a light emitting diode (LED), an organic light emitting diode (OLED), a liquid crystal display, a cathode ray tube display (CRT), a touchscreen, a tactile output device, a printer, speakers, etc.). In some examples, the interface circuit 920 includes a graphics driver card, a graphics driver chip or a graphics driver processor.

The interface circuit 920 of the illustrated example also includes a communication device 335 such as a transmitter, a receiver, a transceiver, a modem and/or network interface card to facilitate exchange of data with external machines (e.g., computing devices of any kind) via a network 926 (e.g., an Ethernet connection, a digital subscriber line (DSL), a telephone line, coaxial cable, a cellular telephone system, etc.).

The processor platform 900 of the illustrated example also includes mass storage devices 928 for storing software and/or data. Examples of such mass storage devices 928 include floppy disk drives, hard drive disks, compact disk drives, Blu-ray disk drives, RAID systems, and digital versatile disk (DVD) drives.

The coded instructions 932 of FIG. 9, represented generally in FIGS. 4-8, may be stored in the mass storage device 928, in the volatile memory 914, in the non-volatile memory 916, and/or on a removable tangible computer readable storage medium such as a CD, DVD or solid-state memory device.

The processor platform 900 of the illustrated example also includes an example clock 934. In some examples, the example clock 934 is to operatively associate a time of each interaction between a user and the example door access device 100 in the example data log 364. In some examples, the example clock 934 is to provide time data to the example time manager 330 to enable the example time manager 330 to compare a time of an access attempt to the example time restriction data 363, if any, associated with the identified user in example memory 353.

The example door access device 100 permits authorized users, such as homeowners, to preselect all authorized users (e.g., family, friends, housekeepers, caretakers for pets, etc.) for door access to the premises and to control and/or monitor ingress and egress of the authorized users without the need for physical keys. If a person who is an unauthorized user needs access to the restricted area (e.g., the homeowner's home), the unauthorized user can send their fingerprint data to the authorized user to enter into the example fingerprint data 360. In another example, a homeowner may remotely open the example door 102 for an unauthorized user using a fingerprint reading application on the user's example personal electronic device 175. A fingerprint of the unauthorized person obtained via the example door access device 100 may then be stored in the example fingerprint data 360 as an authorized user.

The example door access device 100 permits authorized users, such as homeowners, to open the front door of their home through natural movements to engage the door handle of the front door. No keys are required. No juggling of carried items is required. There is no risk of being inadvertently locked out of the house if keys are misplaced.

In some examples, the example fingerprint reader 150 is integrated into a door bell, or other hardware of the example door 102, rather than on an example rear surface 140 of an example door handle 115.

In some examples, the example door access device 100 is built into the example door handle 115. In some examples, the example door access device 100 is an add-on device installable in and/or on existing example door handle assemblies 110.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A door access system, comprising:
a door handle to open a door; and
a fingerprint reader disposed on a rear side of the door handle to read a fingerprint from a user touching the rear side of the door handle, the fingerprint reader obscured from view from a vantage of the user attempting to open the door.

2. The door access system of claim 1, further including:
a lock;
an actuator to lock or to unlock the lock;
a lock activator to cause the actuator to lock or to unlock the lock;
a latch moveable between an extended position and a retracted position when the lock is unlocked; and
at least one of a thumb piece and a rotary member responsive to at least one of depression of the thumb piece and rotation of the rotary member to move the latch from the extended position to the retracted position when the lock is unlocked.

3. The door access system of claim 2, further including:
a database including fingerprint data for an authorized user;
a fingerprint matcher to match a fingerprint read by the fingerprint reader with a fingerprint in the fingerprint data.

4. The door access system of claim 3, further including an identifier to actuate the actuator to at least one of (a) unlock the lock in response to a match between the fingerprint read by the fingerprint reader and a fingerprint in the fingerprint data and (b) to lock the lock in response to a failure to match the fingerprint read by the fingerprint reader with a fingerprint in the fingerprint data.

5. The door access system of claim 4, further including a communicator to notify a user responsive to the failure to match the fingerprint read by the fingerprint reader with a fingerprint in the fingerprint data.

6. The door access system of claim 4, further including:
a clock to determine a time at which the fingerprint was read by the fingerprint reader; and
a time manager to compare the time at which the fingerprint was read to a set of authorized times for the user stored in time restriction data in the database to determine if the time is an authorized time and to enable actuation of the actuator by the identifier only if time corresponds to an authorized time for the user.

7. The door access system of claim 6, further including:
an electronic device sensor to identify an electronic device carried by the user; and
an electronic device matcher to match the electronic device carried by the user to an electronic device associated with the user in the database, the electronic device matcher to actuate the actuator to unlock the lock in response to a match between the electronic device carried by the user and an electronic device associated with the user in the database.

8. The door access system of claim 6, further including:
a biometric sensor to identify biometric data of the user; and
a biometric matcher to match the biometric data to biometric data associated with the user in the database, the biometric matcher to actuate the actuator to unlock the lock in response to a match between the biometric data collected by the sensor and the biometric data associated with the user in the database.

9. The door access system of claim 1, further including a database including fingerprint data for an authorized user and a fingerprint matcher to match the fingerprint read by the fingerprint reader with a fingerprint in the fingerprint data.

10. The door access system of claim 1, further including a second door handle, disposed on a second side of the door, the second door handle including a second fingerprint reader disposed on a rear side of the second door handle to read a fingerprint from the user when the user touches the rear side of the second door handle, the second fingerprint reader obscured from view from a vantage of the user attempting to open the door from the second side of the door.

11. A method of controlling access through a door, comprising:
reading a fingerprint of a user touching a rear side of a door handle using a fingerprint reader obscured from view on the rear side of the door handle;
comparing the fingerprint of the user to fingerprint data of authorized users in a database; and
unlocking a door lock if a match is found between the fingerprint of the user and a fingerprint in the fingerprint data.

12. The method of claim 11, further including automatically locking the door lock responsive to a failure to identify a match between the fingerprint read by the fingerprint reader with a fingerprint in the fingerprint data.

13. The method of claim 12, further including notifying a user of a failure to identify a match between the fingerprint read by the fingerprint reader with a fingerprint in the fingerprint data.

14. The method of claim 11, further including:
determining a time at which the fingerprint of the user was read;
comparing the time at which the fingerprint was read to a set of authorized times for the user stored in the database; and
unlocking the door lock only if a match is identified between the time and an authorized time for the user.

15. The method of claim 11, further including adding at least one of a fingerprint, biometric data, or an authorized time to the database.
